(19) United States
(12) Patent Application Publication
(10) Pub. No.: US 2004/0228129 A1
(43) Pub. Date: Nov. 18, 2004

(54) Security nightlight for children

(76) Inventor: Todd A. Sanders, Ponte Vedra Beach, FL (US)

Correspondence Address: Mark J. Young, 9951 Alantic Blvd, Suite 227, Jacksonville, FL, 32225, US

(21) Appl. No.: 10/435,735

(22) Filed: May 12, 2003

(51) Int. Cl. F21V 1/00

(52) U.S. Cl. 362/276; 362/802

(57) ABSTRACT

A device for helping children overcome nighttime fears includes a housing, a power supply, a switch, a means for emitting light and a faux transmitting member. When activated, the device produces a light to visibly indicate it is operating. The faux transmitter member in combination with the light convinces a child that signals are being emitted to protect the child and repel unwanted creatures. The light may be a flashing LED. The device may further include a light sensor for activation in the dark, a manual adjustment for adjusting the flashing rate of the LED and hanging means for suspending the device from an object.

### FIELD OF THE INVENTION

The present invention pertains to a night light for children. More particularly, the present invention relates to a night light for helping children overcome fear of monsters.

### BACKGROUND

Many young children experience a stage during which they fear monsters at bedtime. Such phobias are a natural part of childhood, but can be unnerving for both children and their parents. Children understand that the dark conceals things that are still there, but do not have enough sophistication to know that critters do not just materialize in the dark. They can easily imagine that monsters or other frightening creatures appear in the dark. Shadows, a pile of toys, a branch swinging in the wind outside a window and sounds may all be misinterpreted as monsters.

While psychology experts encourage parents to discuss such fears with their children, attempts to rationalize with the child often prove to be a fruitless endeavor. It may be impossible to talk a child out of the fear until he or she has reached a more advanced developmental stage.

What is needed is a device to help children minimize and eventually overcome the fear of monsters. The device should be safe as well as credible and easy for a child to comprehend. It should make the child feel safer at night, without interfering with sleep. Preferably, the device can be phased out over time.

### SUMMARY

A device in accordance with a preferred embodiment of the present invention is comprised of a housing, a power supply, a switch, a means for emitting light and a faux transmitting member. When activated, the device produces a subtle light to visibly indicate it is operating. The faux transmitter member in combination with the light convinces a child that signals are being emitted to prevent any monsters from entering the premises.

It is therefore an object of the present invention to provide a device to help children minimize and eventually overcome the fear of monsters.

It is another object of the present invention to provide a device that is safe and credible and easy for a child to comprehend.

It is yet another object of the present invention to provide a device that makes a child feel safer at night, without interfering with sleep.

It is still another object of the present invention to provide a device that can be phased out over time.

### BRIEF DESCRIPTION OF THE DRAWINGS

The foregoing and other objects, features and advantages of the present invention will become better understood with reference to the following description, appended claims, and accompanying drawings, where:

FIG. 1 provides a top perspective view conceptually illustrating an exemplary device in accordance with a preferred implementation of the present invention.

FIG. 2 provides a bottom perspective view conceptually illustrating an exemplary device in accordance with a preferred implementation of the present invention.

FIG. 3 conceptually illustrates an alternative exemplary device in accordance with a preferred implementation of the present invention.

FIG. 4a conceptually illustrates a circuit for use in an exemplary device in accordance with an exemplary embodiment of the present invention.

FIG. 4b conceptually illustrates a portion of a circuit for use in an exemplary device in accordance with an alternative embodiment of the present invention.

### DETAILED DESCRIPTION

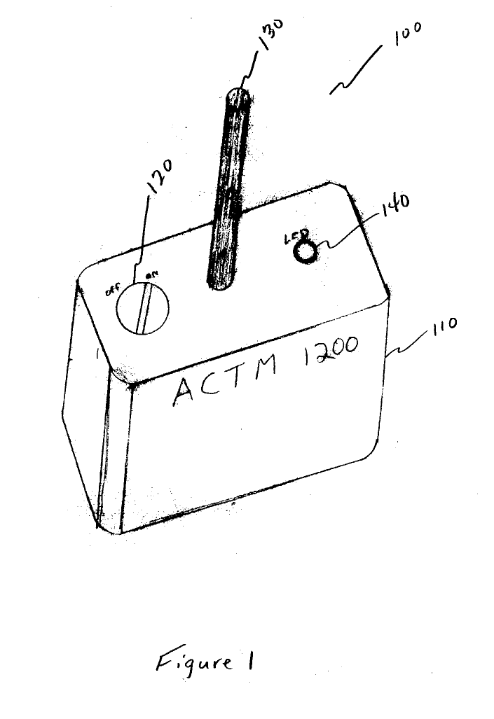

Referring now to FIG. 1, a top surface perspective view of a device 100 in accordance with an exemplary embodiment of the present invention is conceptually shown. The exemplary device is comprised of a housing 110, a switch 120, means for emitting light 130 and a faux transmitting member 140. Each of these components, and other components, are discussed more fully below.

The housing 110 provides a container for internal components, which may include circuitry and a power supply. The housing also provides a base for mounting a manual switch, a light source, and a light sensitive switch, such as a photoresistor. The housing preferably includes a top surface, bottom surface, front surface and back surface. The bottom surface forms a base, which is preferably broad enough to provide a stable support surface for the device.

The housing 110 is preferably comprised of a plastic, such as polyvinyl chloride (PVC), polyethylene, polypropylene, polystyrene, acrylics, cellulosics, acrylonitrile-butadiene-styrene terpolymers, urethanes, thermoplastic resins, thermo-plastic elastomers (TPE), acetal resins, polyamides, polycarbonates and polyesters. Though many other materials may be used alone or in combination with the aforementioned materials and/or other materials, without departing from the scope of the present invention, preferably the material is relatively inexpensive and durable, easy to use in manufacturing operations and results in an aesthetically acceptable product. The material may further include additives as known in the art to provide desired properties such as desired colors and/or glow-in-the dark properties. By way of example and not limitation, the housing 110 may be comprised of a transparent material, enabling observation of internal components of the device.

The housing 110 may be produced using any suitable manufacturing techniques known in the art for the chosen material, such as (for example) injection, compression, structural foam, blow, or transfer molding; polyurethane foam processing techniques; vacuum forming; and casting. Preferably the manufacturing technique is suitable for mass production at relatively low cost per unit, and results in an aesthetically acceptable product with a consistent acceptable quality.

In an alternative embodiment, the housing may take the shape of a toy or character (e.g., an action hero), or be designed for attachment to (or insertion in) a toy or character (e.g., in a plush toy), without departing from the scope of the present invention.

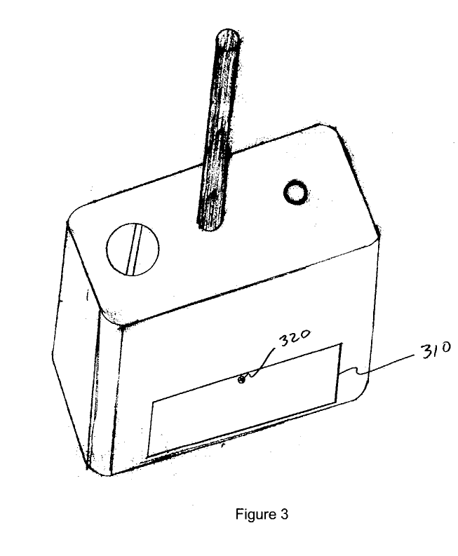

The power supply is preferably comprised of a replaceable battery or batteries placed in a conventional battery compartment in the interior cavity of the housing 110 and held in place with battery spring clips or snaps. The battery may be a conventional 9 volt size cell, which should be capable of providing sufficient electric power storage for long term operation of the device as hereafter described. A removable cover (e.g., 310 in FIG. 3) provides access to the battery compartment. The cover 310 and battery compartment may be shaped, oriented and positioned in any number of ways to accommodate the battery or batteries of choice in a conventional manner. Preferably, however, the cover could not be easily or accidentally removed by a young child. Thus, a screw 320 for securing the cover is preferred. The use of a battery makes the device completely self-contained and eliminates any need to plug it into an AC wall outlet.

As an alternative power supply, a conventional AC plug may be provided for use in a conventional AC outlet. In such case, a transformer would be included, either as an internal component within the housing 110, or as an external component adjacent to the plug. As another alternative power supply, a conventional rechargeable battery with recharging means may be provided.

The light source is preferably a visible, efficient light emitting diode (LED) 140, that can be clearly seen in the dark when illuminated but not so bright as to become a distraction. An incandescent or halogen bulb is not preferred because it would consume power more quickly and risk becoming a distraction. Nevertheless, the present invention is not limited to using an LED as a light source. Other light sources capable of being safely illuminated with a battery or AC power may be used without departing from the scope of the present invention. Those skilled in the art will appreciate that a plurality of light sources, such as two or more LEDs, may be used without departing from the scope of the present invention.

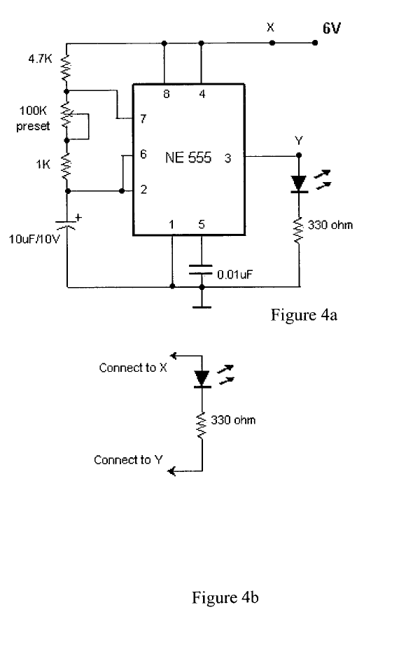

The device preferably includes a circuit for flashing the light source. Such circuits, e.g., oscillator circuits, are well known in the art for flashing one or a plurality of light sources, such as LEDs, in a variety of flashing sequences. Flashing LEDs and bulbs are also commercially available and come within the scope of the present invention; however, a separate circuit is preferred for enhanced control of the flashing rate. By way of example and not limitation, a circuit believed to be suitable is shown in FIG. 4a. It uses a 555 timer 410 setup as an oscillator with a variable frequency. The exemplary circuit also includes resistors 430 and 460 through 480, as well capacitors 440 and 450 and LED 420. The flashing frequency can be adjusted by adjusting the capacitance. For example, by using a 22 μF capacitor instead of a 10 μF capacitor 450 (shown), the frequency changes from an estimated 1 flash per 0.5 second to 1 flash per second. Those skilled in the art will appreciate that other circuits (e.g., programmed microcontroller-based circuits) and other LED configurations can be used without departing from the scope of the present invention. Examples of other flashing LED circuits are provided in U.S. Pat. Nos. 4,514,789 and 4,228,484.

In an alternative embodiment, the housing of the device may take the form of a toy, such as a superhero toy. A pair of flashing LED eyes may be provided. The eyes may flash simultaneously or alternately.

In an alternative embodiment, a means for adjusting the light source blinking rate may be provided. For example, an adjustable capacitor (not shown) may be provided with a connection to a control 170 (e.g., a dial or slider) mounted on the housing. The control 170 would enable manual adjustment of capacitance and therefore blinking rate. Advantageously, such an embodiment would enable manual adjustment of the flashing rate to suit personal preferences. It would also preferably enable manually increasing the flashing rate to a maximum rate enabled by the capacitor. Such a maximum rate can be used in tense moments to provide an increased sense of security. Furthermore, over time, the flashing rate can be decreased to wean a child off the device. Thus for example, periodically, a parent may slightly decrease the flashing rate until it reaches a minimum. This could help gradually reduce a child's dependency on the device for nighttime comfort.

Additionally, a light sensor means 160 for enabling illumination and flashing of the LED only in darkness may be provided. By way of example, a photoresistor, photodiode or phototransistor may be connected to the flashing circuit to disable illumination and flashing when light is detected. As one example, the sensor means may be connected to the circuit such as to cause a break in the circuit or a short circuit when the sensed ambient light exceeds a determined threshold. Such uses of light sensor means and such connections are known in the art. As one example, U.S. Pat. No. 4,514,789 discloses use of a phototransistor and resistor to disable the flashing circuit when the sensed ambient light exceeds a determined threshold. When the level of sensed ambient light falls below a determined level, the light sensor means preferably turns off and the LED flashes. Advantageously, such a device conserves power. Additionally, it creates the appearance to a child that the device is “smart” by operating only when necessary. Such a perception increases the likelihood of acceptance by a child and the effectiveness of the device in helping a child cope with a nighttime phobia. Alternate light sensor means and circuit connections to achieve the desired operational effect are known in the art and may be used without departing from the scope of the present invention.

A visible faux transmitting member 130 is provided to convince a child that the device is capable of emitting protective signals (e.g., monster repelling signals). Without the visible faux transmitting member, it is believed that a child is more likely to reject the device. Children of today are capable of understanding the concept of transmitters and signals, as featured on television programs, in cartoons, children's books, and appliances encountered in everyday life. It is not necessary that the antenna or transmitting member identically resemble an actual antenna used on a device having transmitting capabilities, so long as it is likely to be perceived by a child as a functional transmitting member. The transmitting member therefore serves an important psycho-visual function, i.e., increasing the credibility of the device to a child, which is considered advantageous to the acceptance of the device by the child and its overall effectiveness in providing a sense of security and helping overcome a phobia.

In a preferred embodiment, the faux transmitting member 130 resembles a transmitting member that may be familiar to a child. For example, many children are familiar with antennas of cellular and cordless phones. Given the likelihood of contact with a child, the faux antenna or transmitting member 130 preferably has a safe and durable construction. For example, rigid protruding devices that can be easily broken and have sharp or pointed ends or edges are disfavored for obvious safety reasons; while a flexible and durable device with a rounded or blunt tip and no sharp edges is preferred. By way of example, and not limitation, a flexible rubber faux antenna resembling a cellular telephone antenna may be used. The faux transmitting member 130 may be stationary or adjustable (e.g., telescoping, extendable or rotatable).

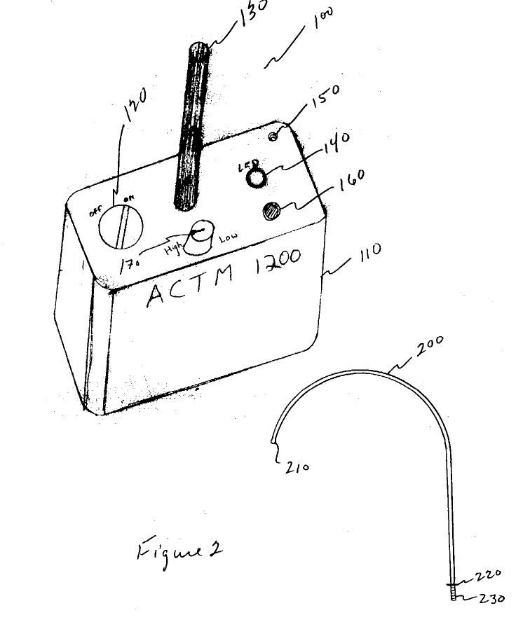

In another embodiment, a device in accordance with the present invention may include a hanging means. For example, a hanger 200 (as in FIG. 2), may be provided. By way of example, the hanger may include a candy cane shaped member having a rounded or blunt first free end 210, and a second male threaded end 230. The male threaded end 230 may be threadedly engaged in the female threaded receptacle 150. Thus, the hanger may be removably attached to the device, enabling suspension in a closet or on a door knob. The size and shape of hangar, the type of hanger, the composition of the hanger and the position and form of attachment to the device may be varied without departing from the scope of the present invention.

The visible faux transmitting member 130 may be an actual transmitting member without departing from the scope of the present invention. However, an actual transmitting member is considered unnecessary and is not preferred. Additionally, an actual transmitting member may be costly and pose a risk to children.

When activated, a device in accordance with an exemplary embodiment of the present invention produces a flashing light to visibly indicate it is operating. The faux transmitter member in combination with the light convinces a child that signals are being emitted to prevent monsters from entering the premises. If a light sensing means is provided, the device will preferably function only when the sensed ambient light drops below a determined level, thus conserving battery power and creating the appearance of an intelligent device.

A method of using the device to help a child overcome a phobia preferably entails the following steps. First, an adult should preferably introduce the device to the child as a device that claims to be able to transmit signals that repel unwanted creatures (e.g., monsters). Second, the adult should review the device with the child, explaining the functions of the components as the adult desires the child to perceive them. Third, the adult should locate the device in a location of the child's bedroom that seems to cause the child the greatest fear. A plurality of devices may be used without departing from the scope of this invention. Fourth, the device should be activated. If the device is not equipped with a light sensor, it should preferably be activated in the evening before the child goes to bed. If the device is equipped with a light sensor, it may be left on all of the time or activated in the evening before the child goes to bed. If the device is equipped with a means for manually adjusting the rate of flashing, the rate should at first preferably be set between highest and lowest. Thus, the adult may reserve the highest (fastest) flashing for tense moments, such as if the child believes he or she saw a monster. Over time, the adult may gradually decrease the rate of flashing to wean the child from the device. The rate of flashing may thus also serve as a quantifiable indicator of the child's fear and dependency.

A parent may decide to position a plurality of the devices in locations where a child can easily imagine that monsters or other frightening creatures lurk. For example, a child might express fear of creatures in a closet, under a bed, in an attic or basement, or behind or under a piece of furniture. Such locations are typical sources of fear for young children. If a device is equipped with a hanger as described above, it may be hung in a closet, on a doorknob or from a similar object. Consistent with the methodology described above, one or more of the devices may also be placed within view of the child. The presence of the device and/or the knowledge that the device has been placed at a location of concern will soothe the child, thus achieving a desired calming effect.

The foregoing detailed description of particular preferred implementations of the invention, which should be read in conjunction with the accompanying drawings, is not intended to limit the enumerated claims, but to serve as particular examples of the invention. Those skilled in the art should appreciate that they can readily use the concepts and specific implementations disclosed as bases for modifying or designing other methods and systems for carrying out the same purposes of the present invention. Those skilled in the art should also realize that such equivalent methods and systems do not depart from the spirit and scope of the invention as claimed.

Having thus described the present invention, what is claimed as new and desired to be secured by Letters Patent is as follows:

1. A security nightlight including a housing, a power supply, a switch, a means for emitting light and a faux transmitting member.

2. A security nightlight according to claim 1 wherein the means for emitting light includes an LED and means for making the LED flash.

3. A security nightlight according to claim 2, wherein the means for making the LED flash includes an oscillator circuit.

4. A security nightlight according to claim 1, further including a light sensor means for disabling the light emitting means when sensed ambient light exceeds a determined threshold.

5. A security nightlight according to claim 4, wherein the light sensor means includes a sensor from the group consisting of a photoresistor, phototransistor, and photodiode.

6. A security nightlight according to claim 2, further including a manual adjustment means for adjusting the flashing rate of the LED.

7. A security nightlight according to claim 6, wherein the manual adjustment means includes a variable resistor.

8. A security nightlight according to claim 7, wherein the manual adjustment means includes a variable capacitor.

9. A security nightlight according to claim 2, further including a means for hanging the security nightlight from an object, said means being attached to the security nightlight.

10. A security nightlight according to claim 9, wherein the means for hanging the security nightlight from an object is releasably attached to the security nightlight.

11. A security nightlight according to claim 1, wherein the means for emitting light includes an LED and means for making the LED flash, and the security nightlight further includes a light sensor means for disabling the light emitting means when sensed ambient light exceeds a determined threshold, a manual adjustment means for adjusting the flashing rate of the LED.

12. A method of helping a child overcome a nighttime related phobia, said method including steps of introducing a security nightlight according to claim 11 to the child, locating the device in a location that seems to cause the child gfear or concern, and activating the device.

13. A method according to claim 12, further including steps of manually adjusting the rate of flashing.

14. A method according to claim 13, further including steps of manually adjusting the rate of flashing such that over time, the rate is gradually decreased.
